(19) United States
(12) Patent Application Publication
(10) Pub. No.: US 2024/0381178 A1
(43) Pub. Date: Nov. 14, 2024

(54) MANAGEMENT NODE IN WIRELESS COMMUNICATION SYSTEM WITH NETWORK SLICING ENVIRONMENT AND OPERATING METHOD THEREOF

(71) Applicant: Samsung Electronics Co., Ltd., Suwon-si (KR)

(72) Inventors: Przemyslaw WYSZKOWSKI, Warszawa (PL); Jan KIENIG, Warszawa (PL); Maciej LISOWSKI, Warszawa (PL); Mateusz ZAWADZKI, Warszawa (PL)

(21) Appl. No.: 18/675,615

(22) Filed: May 28, 2024

Related U.S. Application Data
(63) Continuation of application No. PCT/KR2024/005839, filed on Apr. 30, 2024.

(30) Foreign Application Priority Data
May 10, 2023 (KR) 10-2023-0060312
May 31, 2023 (KR) 10-2023-0070246

(51) Int. Cl. H04W 28/086; H04W 28/02; H04W 72/0453

(52) U.S. Cl. CPC H04W 28/0864; H04W 28/0205; H04W 72/0453

(57) ABSTRACT

A management node in a wireless communication system with a network slicing environment and an operating method thereof are provided. The method may include, in response to an allocation request from a higher-level management node, allocating a lower-level management node a first slicing entity that meets specified requirements for a network slice, obtaining the occurrence of a reallocation event, and in response to the occurrence of the reallocation event, reallocating the lower-level management node a second slicing entity that meets the specified requirements among slicing entities managed by the management node.

### CROSS-REFERENCE TO RELATED APPLICATION(S)

This application is a continuation application, claiming priority under § 365(c), of an International application No. PCT/KR2024/005839, filed on Apr. 30, 2024, which is based on and claims the benefit of a Korean patent application number 10-2023-0060312, filed on May 10, 2023, in the Korean Intellectual Property, and of a Korean patent application number 10-2023-0070246, filed on May 31, 2023, in the Korean Intellectual Property, the disclosure of each of which is incorporated by reference herein in its entirety.

### TECHNICAL FIELD

The disclosure relates to a management node in a wireless communication system and an operating method thereof. More particularly, the disclosure relates to a management node that manages network entities in a wireless communication system with a network slicing environment, and an operating method thereof.

### BACKGROUND ART

Fifth generation (5G) mobile communication technology defines a wide frequency band to enable fast transmission speeds and new services, and is also possible to be implemented not only in a 6 giga hertz (GHz) below frequency band (‘Sub 6 GHz’) such as 3.5 gigahertz (3.5 GHz) but also in an ultra-high frequency band (‘Above 6 GHz’) called a millimeter wave (mm Wave) such as 28 GHz and 39 GHz. Also, in 6G mobile communication technology called a beyond 5G system, implementation in Terahertz bands (e.g., 95 GHz to 3 THz bands) is being considered to achieve a transmission speed that is 50 times faster than 5G mobile communication technology and an ultra-low delay time that is reduced to one tenth.

In the early days of 5G mobile communication technology, with the goal of supporting services and meeting performance requirements for enhanced Mobile BroadBand (eMBB), ultra-reliable low-latency communications (URLLC), and massive machine-type communications (mMTC), standardization has been carried out for beamforming and massive multiple input multiple output (massive MIMO) for mitigating a path loss of radio waves and increasing a transmission distance of radio waves in an ultra-high frequency band, various numerology support (multiple subcarrier interval operation, etc.) for efficient use of ultra-high frequency resources and a dynamic operation of slot format, an initial access technology for supporting multiple beam transmission and broadband, the definition and operation of band-width part (BWP), a new channel coding method such as a low density parity check (LDPC) code for large-capacity data transmission and a polar code for highly reliable transmission of control information, L2 pre-processing, and network slicing that provides dedicated networks specialized for specific services, etc.

Currently, discussions are in progress to improve and enhance the initial 5G mobile communication technology in consideration of services that 5G mobile communication technology intended to support. In addition, physical layer standardization is in progress for technologies such as vehicle-to-everything (V2X) for helping autonomous vehicles make driving decisions and increasing a user convenience, based on a vehicle's own location and status information, new radio unlicensed (NR-U) which aims to operate a system that meets various regulatory requirements in unlicensed bands, an NR UE power saving technology, a non-terrestrial network (NTN) which is direct terminal-satellite communication for securing coverage in areas where communication with a terrestrial network is impossible, positioning, etc.

Standardization is also in progress in the field of wireless interface architecture/protocol for technologies such as industrial Internet of things (IIoT) for supporting new services through linkage and convergence with other industries, integrated access and backhaul (IAB) which provides a node for expanding a network service area by integrating and supporting a wireless backhaul link and an access link, mobility enhancement which includes conditional handover and dual active protocol stack (DAPS) handover, 2-step random access (2-step RACH for NR) which simplifies a random access procedure, etc. Standardization is also in progress in the field of system architecture and services for 5G baseline architecture (for example, service based architecture and service based interface) for incorporating network functions virtualization (NFV) and software-defined networking (SDN) technologies, mobile edge computing (MEC) which receives services, based on a location of a terminal, etc.

When this 5G mobile communication system is commercialized, connected devices which are growing explosively will be connected to a communication network. Accordingly, it is expected that the strengthening of the function and performance of the 5G mobile communication system and the integrated operation of the connected devices will be required. To this end, new researches will be conducted on eXtended Reality (XR) for efficiently supporting augmented reality (AR), virtual reality (VR), mixed reality (MR), etc., 5G performance improvement and complexity reduction which utilize artificial intelligence (AI) and machine learning (ML), AI service support, metaverse service support, drone communication, etc.

The development of this 5G mobile communication system could become a foundation of the development of not only a multiple antenna transmission technology such as new waveform, full dimensional multiple input multiple output (FD-MIMO), array antennas, and large scale antennas, for ensuring coverage in a terahertz band of 6G mobile communication technology, a high-dimensional spatial multiplexing technology which uses a metamaterial-based lens and antenna and an orbital angular momentum (OAM) to improve the coverage of terahertz band signals, and a reconfigurable intelligent surface (RIS) technology, but also a full duplex technology for improvement of a frequency efficiency of 6G mobile communication technology and improvement of a system network, an AI-based communication technology which realizes system optimization by utilizing a satellite and an artificial intelligence (AI) from a design stage and internalizing an end-to-end AI support function, a next-generation distributed computing technology which realizes services of complexity beyond the limits of terminal computing capabilities by utilizing ultra-high-performance communication and computing resources.

Meanwhile, in a wireless communication system such as a 5G mobile communication system, network slicing can be network architecture that enables the multiplexing of virtualized and independent logical networks in the same physical network infrastructure. Each network slice (or subnet) can mean an isolated end-to-end network adjusted to meet various requirements requested by a specific application. Through a network slicing technology, a plurality of virtualized logical networks can exist even within one physical network.

The above information is presented as background information only to assist with an understanding of the disclosure. No determination has been made, and no assertion is made, as to whether any of the above might be applicable as prior art with regard to the disclosure.

### DISCLOSURE

### Technical Solution

Aspects of the disclosure are to address at least the above-mentioned problems and/or disadvantages and to provide at least the advantages described below. Accordingly, an aspect of the disclosure is to provide a management node in a wireless communication system and an operating method thereof.

Additional aspects will be set forth in part in the description which follows and, in part, will be apparent from the description, or may be learned by practice of the presented embodiments.

In accordance with an aspect of the disclosure, an operating method of a management node in a wireless communication system with a network slicing environment is provided. The method includes, in response to an allocation request from a higher-level management node, allocating a lower-level management node a first slicing entity that meets specified requirements for a network slice, obtaining the occurrence of a reallocation event, and in response to the occurrence of the reallocation event, reallocating the lower-level management node a second slicing entity that meets the specified requirements among slicing entities managed by the management node.

In accordance with another aspect of the disclosure, a management node is provided. The management node includes a transceiver, memory storing one or more computer programs, and one or more processors communicatively coupled to the transceiver and the memory. The one or more computer programs include computer-executable instructions that, when executed by the one or more processors, cause the management node to, in response to an allocation request from a higher-level management node, allocate a lower-level management node a first slicing entity that meets specified requirements for a network slice, obtain the occurrence of a reallocation event, and in response to the occurrence of the reallocation event, reallocate the lower-level management node a second slicing entity that meets the specified requirements among slicing entities managed by the management node.

In accordance with another aspect of the present invention, one or more non-transitory computer-readable storage media are provided. The non-transitory computer-readable storage media store one or more computer programs including computer-executable instructions that, when executed by one or more processors of a management node, cause the management mode to perform operations, the operations including, in response to an allocation request from a higher-level management node, allocating a first slicing entity that meets specified requirements for a network slice, to a lower-level management node, obtaining the occurrence of a reallocation event, and in response to the occurrence of the reallocation event, reallocating a second slicing entity that meets the specified requirements among slicing entities managed by the management node, to the lower-level management node.

Other aspects, advantages, and salient features of the disclosure will become apparent to those skilled in the art from the following detailed description, which, taken in conjunction with the annexed drawings, discloses various embodiments of the disclosure.

### DESCRIPTION OF DRAWINGS

The above and other aspects, features, and advantages of certain embodiments of the disclosure will be more apparent from the following description taken in conjunction with the accompanying drawings, in which:

FIG. 1 illustrates a communication network including network entities in a wireless communication system according to an embodiment of the disclosure;

FIG. 2A is a diagram exemplifying the structure of network slices in a wireless communication system according to an embodiment of the disclosure;

FIG. 2B illustrates the construction of a management node in a wireless communication system according to an embodiment of the disclosure;

FIG. 3 is a flowchart illustrating an operating method of a management node in a wireless communication system according to an embodiment of the disclosure;

FIG. 4 is a ladder diagram illustrating a method of reallocating a slicing entity by a break before make technique in a wireless communication system according to an embodiment of the disclosure;

FIGS. 5A and 5B are ladder diagrams illustrating operations before the execution of reallocation when reallocating a slicing entity by a break before make technique in a wireless communication system according to various embodiments of the disclosure;

FIGS. 6A and 6B are diagrams for explaining a reallocation triggering condition in a wireless communication system according to various embodiments of the disclosure;

FIGS. 7A and 7B are ladder diagrams illustrating reallocation execution operations when reallocating a slicing entity by a break before make technique in a wireless communication system according to various embodiments of the disclosure;

FIG. 8 is a ladder diagram illustrating a method of reallocating a slicing entity by a pre-allocation technique in a wireless communication system according to an embodiment of the disclosure; and

FIG. 9 is a ladder diagram illustrating a method of reallocating a slicing entity by a late deprovisioning technique in a wireless communication system according to an embodiment of the disclosure.

The same reference numerals are used to represent the same elements throughout the drawings.

### MODE FOR INVENTION

The following description with reference to the accompanying drawings is provided to assist in a comprehensive understanding of various embodiments of the disclosure as defined by the claims and their equivalents. It includes various specific details to assist in that understanding, but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the disclosure. Accordingly, it should be apparent to those skilled in the art that the following description of various embodiments of the disclosure is provided for illustration purposes only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Methods according to various embodiments of the disclosure may be implemented in the form of hardware, software, or a combination of hardware and software. When the methods are implemented by software, a computer-readable storage medium that stores one or more programs (software modules) may be presented. The one or more programs stored in the computer-readable storage medium are configured to be executable by one or more processors within an electronic device. The one or more programs include instructions of allowing the electronic device to execute methods of embodiments described in the claims or specification of the disclosure.

These programs (software modules, software) may be stored in random access memory, non-volatile memory including flash memory, read only memory (ROM), electrically erasable programmable read only memory (EEPROM), a magnetic disc storage device, a compact disc-ROM (CD-ROM), digital versatile discs (DVDs) or other types of optical storage devices, or a magnetic cassette. Or, the programs may be stored in memory consisting of a combination of some or all of these. Also, each configuration memory may also be included in plural numbers.

Also, the program may be stored in an attachable storage device that is accessible through a communication network such as the Internet, an intranet, a local area network (LAN), a wide area network (WAN), or a storage area network (SAN), or a communication network consisting of a combination thereof. This storage device may be connected to a device performing an embodiment of the disclosure through an external port. Also, a separate storage device on a communication network may be connected to the device performing the embodiment of the disclosure.

In various embodiments of the disclosure, constituents are expressed in singular or plural numbers according to a specific embodiment presented. However, singular or plural expressions are selected suitably to a presented situation for convenience of explanation, and the disclosure is not limited to singular or plural constituents, and even constituents expressed in plural number may be composed in singular number, or even constituents expressed in singular number may be composed in plural number.

In the following description, terms referring to signals, terms referring to channels, terms referring to control information, terms referring to network entities, terms referring to constituents of a device, etc. are exemplified for convenience of explanation. Accordingly, the disclosure is not limited to the terms described below, and other terms having equivalent technical meaning may be used.

Also, the disclosure describes various embodiments by using terms used in some communication standards (e.g., 3rd provision partnership project (3GPP)), but this is only an example for explanation. Various embodiments of the disclosure may be easily modified and applied even in other communication systems.

Hereinafter, embodiments of the disclosure will be described in detail with reference to the drawings so that the embodiments can be easily embodied by those skilled in the art to which the disclosure pertains. However, the disclosure may be implemented in several different forms, and is not limited to the embodiments described herein. In relation to the description of the drawings, the same or similar reference numerals may be used for the same or similar constituents. Also, in the drawings and related descriptions, descriptions of well-known functions and constructions may be omitted for clarity and brevity.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

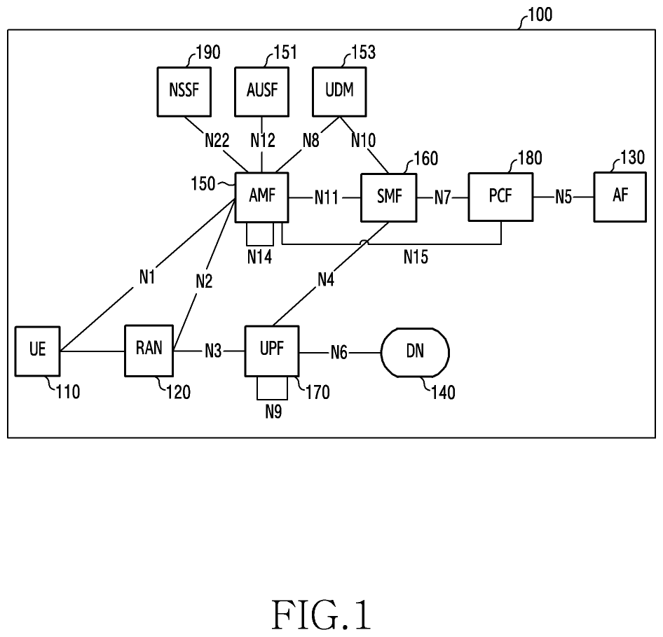

FIG. 1 illustrates a communication network including network entities in a wireless communication system according to an embodiment of the disclosure.

Referring to FIG. 1, a 5G mobile communication network of the wireless communication system 100 may include a user equipment (UE) 110, a radio access network (RAN) 120, and a core network (CN).

The core network is a network that manages the entire system, and may control the RAN 120, and process data and control signals for the UE 110, which are transmitted and received through the RAN 120. The core network may perform various functions such as control of a user plane and control plane, processing of mobility, management of subscriber information, billing, and interlocking with other types of systems (e.g., long term evolution (LTE) system). The core network may perform the various functions described above, by including a plurality of functionally separated entities with different network functions (NFs).

The core network may be configured to include network functions, such as an access and mobility management function (AMF) 150 that presents a mobility management function for a UE, a session management function (SMF) 160 that presents a session management function, a user plane function (UPF) 170 that performs a data transmission role, a policy control function (PCF) 180 that presents a policy control function, a network slice selection function (NSSF) 190 that presents a network slice selection function, a unified data management (UDM) 153 that presents a data management function such as subscriber data and policy control data, or a unified data repository (UDR) that stores data of various network functions, etc. Although not shown in FIG. 1, the core network may further include a communication service management function (CSMF), a network slice management function (NSMF), and a network slice subnet management function (NSSMF), for providing a network slice and confirming a user service.

Referring to FIG. 1, the user equipment (UE) 110 may communicate through a wireless channel formed with a base station (e.g., eNB and gNB), that is, through an access network. The UE 110 may be a device used by a user, and may be a device configured to present a user interface (UI). As an example, the UE 110 may be a terminal equipped in a vehicle for driving. In some other embodiments, the UE 110 may be a device that performs machine type communication (MTC) that operates without user's involvement, or may be an autonomous vehicle. The UE may be referred to as, besides electronic device, ‘terminal’, ‘vehicle terminal’, ‘user equipment (UE)’, ‘mobile station’, ‘subscriber station’, ‘remote terminal’, ‘wireless terminal’, or ‘user device’ or other terms having equivalent technical meaning. As a terminal, a customer-premises equipment (CPE) or a dongle type terminal may be used, in addition to the UE. The customer-premises equipment, like the UEs, may be connected to an NG-RAN node and meanwhile, present a network to other communication devices (e.g., laptops).

Referring to FIG. 1, the AMF 150 presents a function for access and mobility management on a per UE 110 basis, and each UE 110 may be basically connected to one AMF 150. The AMF 150 may perform at least one of signaling between core network nodes for mobility between 3GPP access networks, an interface (N2 interface) between radio access networks (e.g., RAN 120), NAS signaling with the UE 110, identifying of the SMF 160, and presenting of delivery of a session management (SM) message between the UE 110 and the SMF 160. Some or all functions of the AMF 150 may be supported within a single instance of one AMF 150.

Referring to FIG. 1, the SMF 160 presents a session management function, and when the UE 110 has a plurality of sessions, each session may be managed by a different SMF 160. The SMF 160 may perform a function of at least one of session management (e.g., session establishment, modification, and release, including tunnel maintenance between a UPF 170 and an access network node), selection and control of a user plane (UP) function, traffic steering settings for routing traffic to a proper destination in the UPF 170, termination of an SM portion of a NAS message, a downlink data notification (DDN), and an initiator of AN-specific SM information (e.g., delivery to the access network through an N2 interface via the AMF 150). Some or all functions of the SMF 160 may be supported within a single instance of one SMF 160.

In a 3GPP system, conceptual links connecting network functions (NFs) within a 5G system may be referred to as reference points. The reference point may also be referred to as an interface. The following exemplifies the reference points included in the 5G system architecture expressed through FIGS. 1, 2A, 2B, 3, 4, 5A, 5B, 6A, 6B, 7A, 7B, 8, and 9.
N1: Reference point between UE 110 and AMF 150
N2: Reference point between (R)AN 120 and AMF 150
N3: Reference point between (R)AN 120 and UPF 170
N4: Reference point between SMF 160 and UPF 170
N5: Reference point between PCF 180 and AF 130
N6: Reference point between UPF 170 and DN 140
N7: Reference point between SMF 160 and PCF 180
N8: Reference point between UDM 153 and AMF 150
N9: Reference point between two core UPFs 170
N10: Reference point between UDM 153 and SMF 160
N11: Reference point between AMF 150 and SMF 160
N12: Reference point between AMF 150 and authentication server function (AUSF) 151
N13: Reference point between UDM 153 and authentication server function 151
N14: Reference point between two AMF 150
N15: Reference point between PCF 180 and AMF 150 for non-roaming scenarios, and reference point between PCF 180 and AMF 150 within visited network for roaming scenarios.

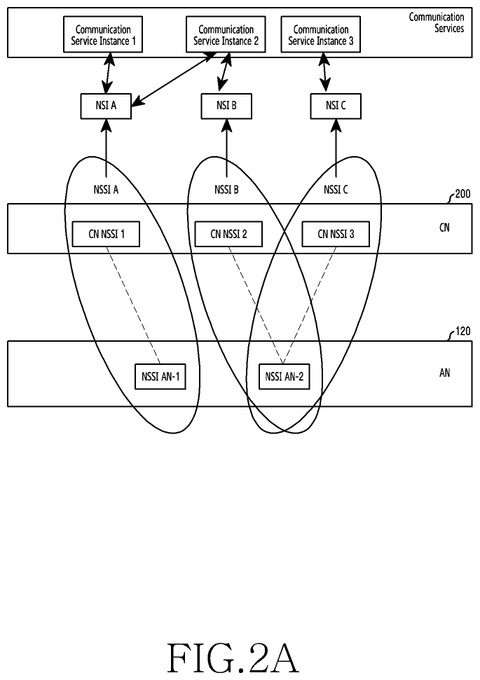

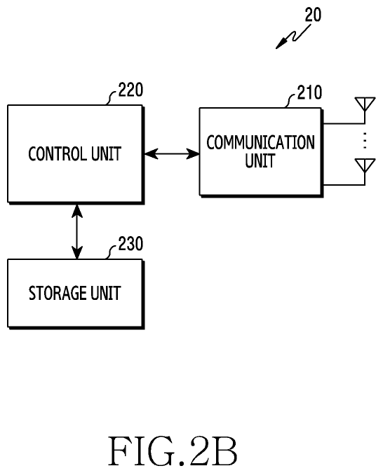

FIG. 2A is a diagram exemplifying the structure of network slices in a wireless communication system according to an embodiment of the disclosure.

Referring to FIG. 2A, by applying a network slicing technology to the wireless communication system (e.g., the 5G mobile communication network of FIG. 1) including an access network (AN) 120 and a core network (CN) 200, several logical networks may be spawned on one physical network infrastructure, and each logical network may be given unique characteristics suitable to specific service requirements. The wireless communication system with a network slicing environment may include slicing entities that are constituents of each network slice (or subnet).

Network slicing may be implemented based on a hierarchical structure of the slicing entities (or network entities). Because the network slices must have complexity and include different management domains, each network slice needs to be composed of independent lower-level building blocks that may include lower-level blocks therein.

The slicing entity may mean an entity subject to management (e.g., allocation, deallocation, or reallocation, etc.) or an entity managed.

The slicing entity that constitutes the network slice may correspond to any one of a communication service instance (CSI), a network slice instance (NSI), a network slice subnet instance (NSSI), a managed function instance (MFI), or a combination thereof. The slicing entities may be managed by dedicated management systems. The dedicated management system may perform network slicing management and/or coordination (e.g., allocation, deallocation, reallocation, etc. of the slicing entity). For example, the dedicated management system may correspond to any one of communication service management function(s) (CSMF) that manages CSIs, a network slice management function(s) (NSMF) that manages NSIs, a network slice subnet management function(s) (NSSMF) that manages NSSIs, a network function management function(s) (NFMF) that manages MFIs, or a combination thereof.

FIG. 2B illustrates the construction of a management node in a wireless communication system according to an embodiment of the disclosure.

Referring to FIG. 2B, the management node 20 may be a device or function of managing one or more slicing entities. The management node 20 may also be referred to as a management entity, a management system, or a management function, etc. The management node 20 may correspond to a device or function of managing a lower-level entity among multi-level entities (higher-level entity and lower-level entity) included in the wireless communication system. For example, the management node 20 may correspond to a function or device corresponding to at least one of CSMF, NSMF, NSSMF, or NFMF. Terms such as ‘ . . . unit’, ‘ . . . er’, etc. used below refer to the unit of processing at least one function or operation, and this may be implemented by hardware, software, or a combination of hardware and software.

Referring to FIG. 2B, the management node 20 may include a communication unit 210 and a control unit 220. The management node 20 may further include a storage unit 230.

The communication unit 210 may present an interface for communicating with other devices in a network. For example, the communication unit 210 may convert a bit string transmitted from the management node 20 to another device (or external electronic device), into a physical signal, and convert a physical signal received from another device, into a bit string. The communication unit 210 may transmit and/or receive signals. Accordingly, the communication unit 210 may be referred to as a modem, a transmitter, a receiver, or a transceiver. The communication unit 210 may support the management node 20 to communicate with other devices or systems via a backhaul connection (e.g., wired backhaul or wireless backhaul) or via a network.

The storage unit 230 may store data such as basic programs, application programs, setting information, etc. for operation of the management node 20. The storage unit 230 may be comprised of volatile memory, non-volatile memory, or a combination of the volatile memory and the non-volatile memory. The storage unit 230 may present stored data according to a request from the control unit 220.

The control unit 220 may include at least one processor electrically and/or operatively connected to the communication unit 210. The control unit 220 may control overall operations of the management node 20. For example, the control unit 220 may transmit and receive signals through the communication unit 210. The control unit 220 may write data to the storage unit 230 or read data from the storage unit 230. The control unit 220 may perform a specified function by executing instructions (or programs) stored in the storage unit 203.

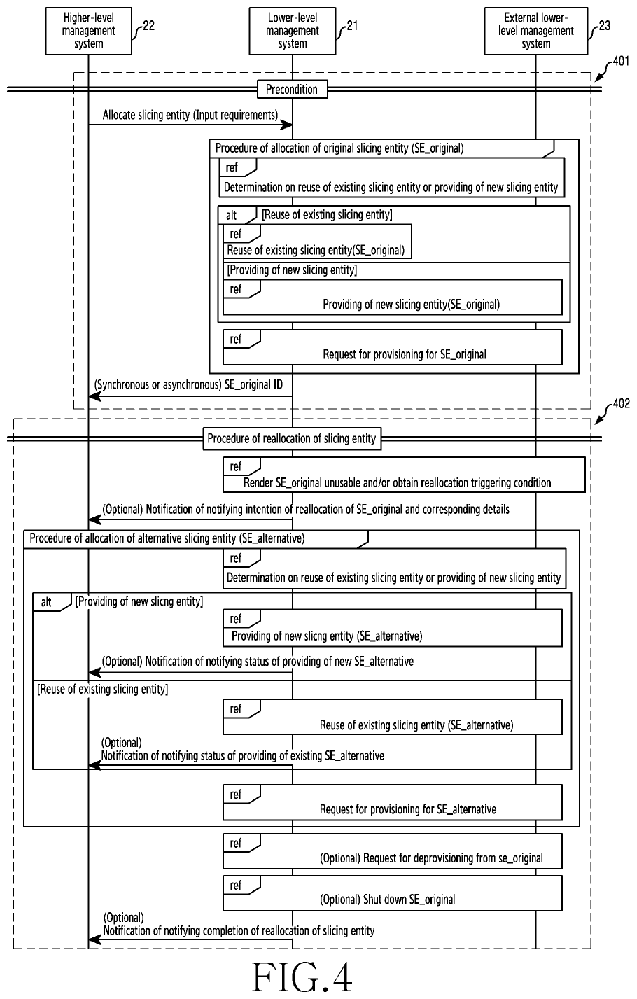

In response to an allocation request from a higher-level management node (e.g., a higher-level management system 22 of FIG. 4), the control unit 220 of the management node 20 (e.g., a lower-level management system 21 of FIG. 4) may allocate a first slicing entity (or original slicing entity) that meets specified requirements for a network slice, to a lower-level management node (e.g., an external lower-level management system 23 of FIG. 4). The control unit 220 may obtain the occurrence of a reallocation event. In response to the occurrence of the reallocation event, the control unit 220 may reallocate a second slicing entity that meets specified requirements among the slicing entities managed by the management node 20, to the lower-level management node.

The control unit 220 may reuse an existing slicing entity among slicing entities managed by the management node 20, as a second slicing entity (or alternative slicing entity).

The control unit 220 may provide a new slicing entity to be used as a second slicing entity (or alternative slicing entity), among slicing entities managed by the management node 20.

When a reallocation triggering condition related to a first slicing entity or a lower-level management node allocated the first slicing entity is met, the control unit 220 may determine that a reallocation event has occurred.

When a specified reallocation triggering condition is met, the control unit 220 may switch a first slicing entity to an inoperable state prior to the reallocation of a second slicing entity.

When a reallocation triggering condition related to a first slicing entity or a lower-level management node allocated the first slicing entity is expected to be met, the control unit 220 may determine that a reallocation event has occurred.

When a specified reallocation triggering condition is expected to be met, the control unit 220 may maintain both a first slicing entity and a second slicing entity in an operational state for a specified time.

The control unit 220 may transmit a notification to a higher-level management node in any one of the steps of start, progress, or completion of a slicing entity reallocation procedure. For example, the control unit 220 may perform one or more of the operations of transmitting a notification of notifying an intention of reallocation of a first slicing entity to the higher-level management node, transmitting a notification of notifying a progress status of reallocation of a second slicing entity to the higher-level management node, and transmitting a notification of notifying the completion of reallocation of the second slicing entity to the higher-level management node. Accordingly, the higher-level management node may perform a procedure (e.g., a procedure of update for operational inventory, database, configuration, etc.) required to maintain integrity between the higher-level management node and the management node 20, based on a notification from the management node 20.

The management node 20 may include at least one of a communication service management function (CSMF), a network slice management function (NSMF), a network slice subnet management function (NSSMF), or a network function management function (NFMF).

Each of the first slicing entity (or original slicing entity) and the second slicing entity (or alternative slicing entity) may include at least one of a communication service instance (CSI), a network slice instance (NSI), a network slice subnet instance (NSSI), or a managed function instance (MFI).

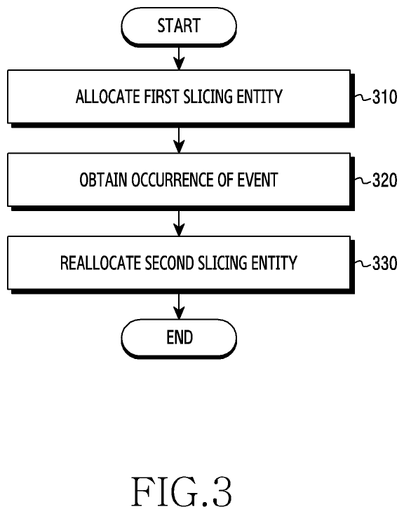

FIG. 3 is a flowchart illustrating an operating method of a management node in a wireless communication system according to an embodiment of the disclosure.

Referring to FIG. 3, a communication network of the wireless communication system may include various multi-level slicing entities (or network entities), and one or more management nodes that manage the slicing entities. The operations of the method shown in FIG. 3 may be performed by the management node 20 of FIG. 2B. However, the method is not limited to this. For example, the operations of the method shown in FIG. 3 may also be performed by a combination of one or more devices or functions. The subject of performing the method shown in FIG. 3 is not limited to hardware constituents. This may be implemented through hardware, software, or a combination of hardware and software. For example, in some embodiments, the method may also be performed by an application installed in the management node 20.

Referring to FIG. 3, the operating method of the management node in the wireless communication system may include operations 310, 320, and 330.

In operation 310, in response to an allocation request from a higher-level management node, the management node 20 (e.g., any one of CSMF, NSMF, NSSMF, NFMF, or a combination thereof) may allocate a lower-level management node a first slicing entity (or original slicing entity) that meets specified requirements (e.g., ServiceProfile requirements or SliceProfile requirements) for one network slice (or subnet).

For example, the management node 20 may correspond to the lower-level management system 21 of FIG. 4. A higher-level management node allocating a slicing entity to the management node 20 may correspond to a higher-level management system 22 of FIG. 4. A lower-level management node allocated a slicing entity from the management node 20 may correspond to a management node of a lower level compared to the management node 20, or a constituent of the management node 20.

In operation 320, the management node 20 may obtain the occurrence of a reallocation event.

When a reallocation triggering condition related to a first slicing entity or a lower-level management node is met, the management node 20 may determine that the reallocation event has occurred. When the reallocation triggering condition is met, the management node 20 may switch the first slicing entity to an inoperable state prior to the reallocation of a second slicing entity.

When the reallocation triggering condition related to the first slicing entity or the lower-level management node is expected to be met, the management node 20 may determine that the reallocation event has occurred. When the reallocation triggering condition is expected to be met, the management node 20 may maintain both the first slicing entity and the second slicing entity in an operational state for a specified time.

In operation 330, in response to the occurrence of the reallocation event obtained through operation 320, the management node 20 may reallocate the lower-level management node the second slicing entity (or an alternative slicing entity) that meets the specified requirements among slicing entities (e.g., CSIs, NSIs, NSSIs, MFIs, or any one of combinations thereof) managed by the management node 20.

The management node 20 may present a procedure for reallocation of slicing entities already allocated to the management node 20. The reallocation procedure may be a procedure for substituting, exchanging, or switching the first slicing entity (or original slicing entity) with the second slicing entity (or alternative slicing entity) that may meet requirements raised for the first slicing entity. The reallocation procedure may be performed autonomously (or internally) by the management node 20.

The management node 20 may perform the reallocation procedure by using the second slicing entity already allocated to itself, without a need to separately request a procedure for deallocation of the first slicing entity and new allocation of another slicing entity to a higher-level management node for reallocation. In a method in which the management node 20 autonomously (or internally) performs the reallocation procedure, an additional support operation, for example, an operation of the higher-level management node for deallocation and new allocation may be unnecessary on the side of the higher-level management node. In this method, the reallocated second slicing entity (or alternative slicing entity) and the existing first slicing entity (or original slicing entity) are slicing entities of the same category both belonging to the same management domain or managed by one management node 20, and may stably meet specified requirements for one network slice (or subnet).

A second slicing entity (or alternative slicing entity) reallocated by the management node 20 may be one of slicing entities already allocated to the management node 20, and may correspond to an existing slicing entity already existing in the management node 20 or a new slicing entity newly provided by the management node 20.

The management node 20 may reuse an existing slicing entity among slicing entities managed by itself, as a second slicing entity (or alternative slicing entity).

The management node 20 may provide a new slicing entity to be used as a second slicing entity (or alternative slicing entity) among slicing entities managed by itself.

A slicing entity reallocation procedure of operation 330 may be executed autonomously (or internally) by the management node 20 (e.g., the lower-level management system 21 of FIG. 4) that manages a first slicing entity (or original slicing entity) given from a higher-level management node (e.g., the higher-level management system 22 of FIG. 4). In this case, it may not be necessary that the reallocation procedure is supported by the higher-level management node or that the higher-level management node recognizes the fact that the reallocation procedure is executed by the lower-level management node 20.

The slicing entity reallocation procedure of operation 330 may be performed using a utility operation triggered by a higher-level management node through an exposed northbound interface (NBI) of the management node 20 (e.g., the lower-level management system 21 of FIG. 4).

The slicing entity reallocation procedure of operation 330 may be explicitly invoked by a high-level management node (or any other actor). For example, the reallocation procedure may be implemented to be exposed to the NBI of the management node 20 wherein the reallocation procedure may be explicitly invoked from the higher-level management node, or may be implemented to be available in internal application programming interfaces (APIs) (not exposed to the NBI) that will be explicitly invoked by an administrator of the management node 20.

A slicing entity reallocation method may correspond to at least any one of a method of reallocating a slicing entity by a break before make technique, a method of reallocating a slicing entity by a pre-allocation technique, a method of reallocating a slicing entity by a late deprovisioning technique, or a combination thereof.

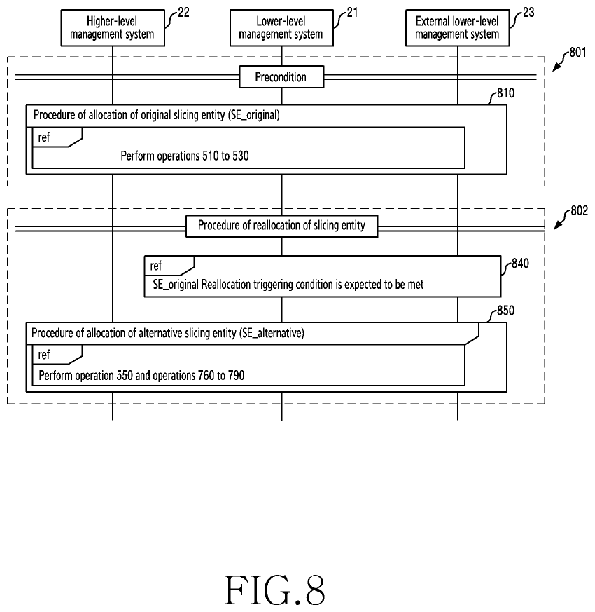

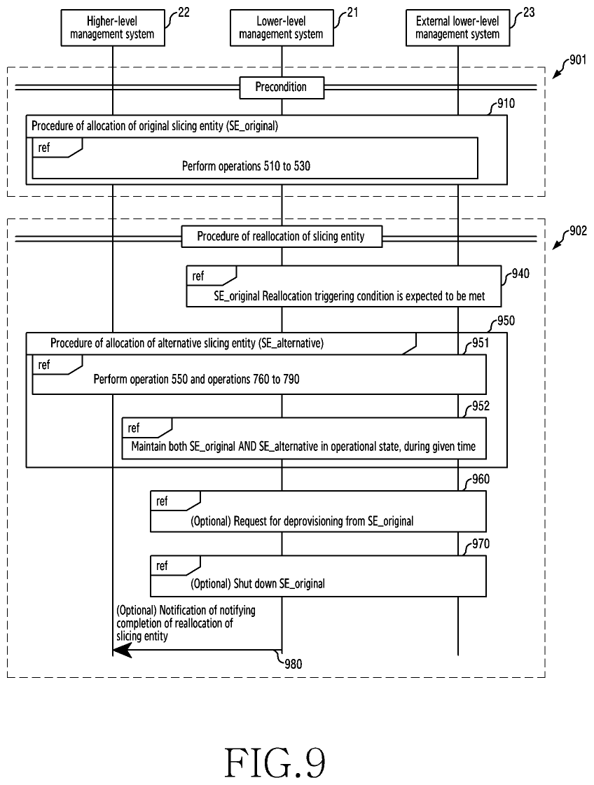

The slicing entity reallocation method using each technique will be described as an example below with reference to FIGS. 4, 5A, 5B, 6A, 6B, 7A, 7B, 8, and 9. FIGS. 4, 5A, 5B, 6A, 6B, 7A, and 7B are examples of the slicing entity reallocation method using the break before make technique according to an embodiment. FIG. 8 is an example of the slicing entity reallocation method using the pre-allocation technique according to an embodiment. FIG. 9 is an example of the slicing entity reallocation method using the late deprovisioning technique according to an embodiment. One or more slicing entity reallocation operations according to various embodiments described below may correspond to each other or may be performed in combination with each other. In some embodiments, at least one of the illustrated operations may be omitted, the order of some operations may be changed, or other operations may also be added. For example, operations indicated as optional in the drawings described later may be omitted according to an embodiment.

FIG. 4 is a ladder diagram illustrating a method of reallocating a slicing entity by a break before make technique in a wireless communication system according to an embodiment of the disclosure.

Referring to FIG. 4, the break before make technique may refer to a reallocation procedure when a reallocation triggering condition is met and the use of an original slicing entity (SE_original) is stopped, before an alternative slicing entity (SE_alternative) is reallocated.

Referring to FIG. 4, a communication network of the wireless communication system may include multi-level management systems 21, 22, and 23. The higher-level management system 22 (e.g., an N+1 level) may be a management node of a higher level compared to the lower-level management system 21 (e.g., an N level). The lower-level management system 21 (e.g., the N level) may be a management node of a higher level compared to the external lower-level management system 23 (e.g., an N−1 level, or a constituent of the lower-level management system 21).

A method of reallocating a slicing entity by a break before make technique may be used when a currently allocated slicing entity is no longer available due to an unexpected event (or a reallocation triggering event, e.g., as a result of a fault affecting the slicing entity).

For example, the external lower-level management system 23 may be a fault management system, and may serve to collect data about a state of a slicing entity managed by the lower-level management system 21 and notify a possible failure (e.g., based on expectation from current situation analysis) or an already occurring failure to the lower-level management system 21. The fault management system may determine to trigger a reallocation to preserve an operational state of a slicing entity affected according to various causes. Accordingly, the external lower-level management system 23 may provide a reallocation event, and trigger the reallocation of the slicing entity by the lower-level management system 21.

Referring to FIG. 4, the operation of reallocating a slicing entity by the break before make technique according to an embodiment may include operations 401 and 402.

Operation 401 exemplifies operations before executing the reallocation of a slicing entity, and may correspond to a precondition for executing the reallocation. Operation 401 may be to allocate an original slicing entity (SE_original). In some embodiments, operation 401 may also be omitted or performed in a different manner.

Operation 402 illustrates a slicing entity reallocation procedure by the break before make technique. Operation 402 may be to reallocate an alternative slicing entity (SE_alternative).

When a specified reallocation triggering condition for triggering reallocation is obtained, it may be necessary for the lower-level management system 21 to notify an intention of performing the reallocation of an original slicing entity, to the higher-level management system 22. The higher-level management system 22 may utilize this notification to potentially affect the execution of a reallocation procedure by the lower-level management system 21. For example, the higher-level management system 22 may approve or object to the execution of a reallocation procedure (potentially within a limited time range).

The lower-level management system 21 may provide a new slicing entity and specify the new slicing entity as an alternative slicing entity to an original slicing entity, or select an existing other slicing entity and specify the other slicing entity as the alternative slicing entity to the original slicing entity. The alternative slicing entity specified by the lower-level management system 21 may meet the requirements allocated to the originally allocated original slicing entity (e.g., expressed as SliceProfile for NSSI or expressed as ServiceProfile for NSI).

As a reallocation procedure is performed, requirements (e.g., a required specification dependent on a SliceProfile, ServiceProfile, or other expressions) may be detached from the originally allocated original slicing entity and be attached to an alternative slicing entity.

Upon completion of executing a reallocation procedure, the lower-level management system 21 may transmit a notification, which includes detailed information on the executed reallocation procedure, to the higher-level management system 22, and update inventory.

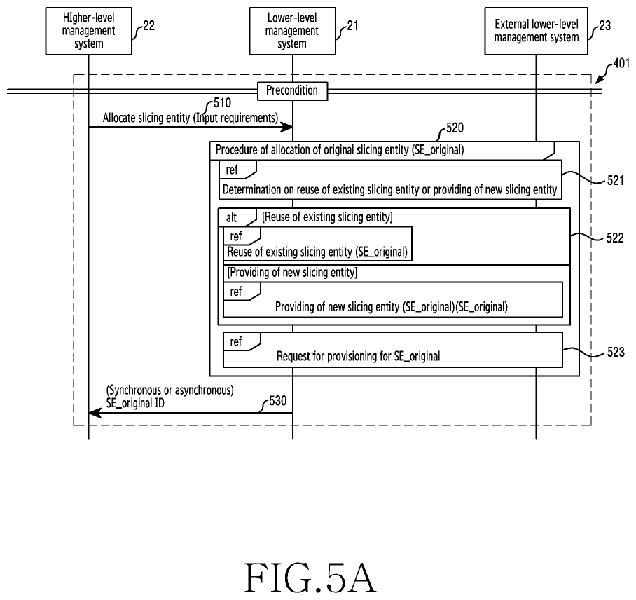

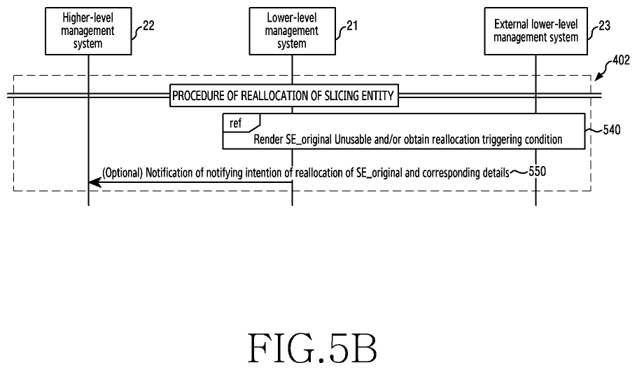

The method of reallocating a slicing entity by the break before make technique, and detailed operations of operations 401 and 402 will be described below in more detail with reference to FIGS. 5A, 5B, 6A, 6B, 7A, and 7B.

FIGS. 5A and 5B are ladder diagrams illustrating operations before the execution of reallocation when reallocating a slicing entity by a break before make technique in a wireless communication system according to various embodiments of the disclosure.

Referring to FIG. 5A, operation 401 exemplifies operations before executing the reallocation of a slicing entity, and may correspond to a precondition for executing the reallocation. Operation 401 may be to allocate an original slicing entity.

Operation 401 may include operations 510, 520, and 530.

In operation 510, by transmitting a slicing entity allocation request to the lower-level management system 21, the higher-level management system 22 may meet specific requirements. The allocation request may include input requirements that a slicing entity to be allocated must meet.

In operation 520, the lower-level management system 21 may execute a procedure of allocation of an original slicing entity (SE_original).

Operation 520 may include operations 521, 522, and 523.

In operation 521, the lower-level management system 21 may determine whether to reuse an existing slicing entity or provide a new slicing entity, based on the input requirements, a monitored network environment, and/or an operation policy.

Operation 522 may include any one of the operation of reusing the existing slicing entity and the operation of providing a new slicing entity. The lower-level management system 21 may selectively execute one of the operation of reusing as an original slicing entity (SE_original) the existing slicing entity that meets the input requirements or the operation of providing as the original slicing entity (SE_original) the new slicing entity that meets the input requirements, according to the determination of operation 521.

In operation 523, the lower-level management system 21 may present provisioning requirements for the original slicing entity (SE_original), to the external lower-level management system 23. Provisioning may mean allocating, arranging, and distributing a system resource suitably to specific requirements for a service, and then preparing a system in advance for immediate use when needed. It may be necessary to perform a management and construction procedure for allocation of the original slicing entity (SE_original) in both the lower-level management system 21 and the external lower-level management system 23 that is a basis of the lower-level management system 21.

Operation 530 may be the operation of returning a handle of the original slicing entity (SE_original). In operation 530, the lower-level management system 21 may transmit a notification of notifying an original slicing entity ID (SE_original ID) to the higher-level management system 22 that has requested the allocation of the slicing entity through operation 510. Single or several notifications may be transmitted. The notification may be transmitted synchronously or asynchronously.

Referring to FIG. 5B, operation 402 may be the operation of obtaining the occurrence of a slicing entity reallocation event.

Operation 402 may include operations 540 and 550.

In operation 540, the lower-level management system 21 may obtain the occurrence of the slicing entity reallocation event. For example, when the original slicing entity (SE_original) is rendered unusable and/or when a reallocation triggering condition is met, the lower-level management system 21 may determine that the reallocation event has occurred. As the occurrence of the corresponding event is obtained, a slicing entity reallocation operation may be triggered.

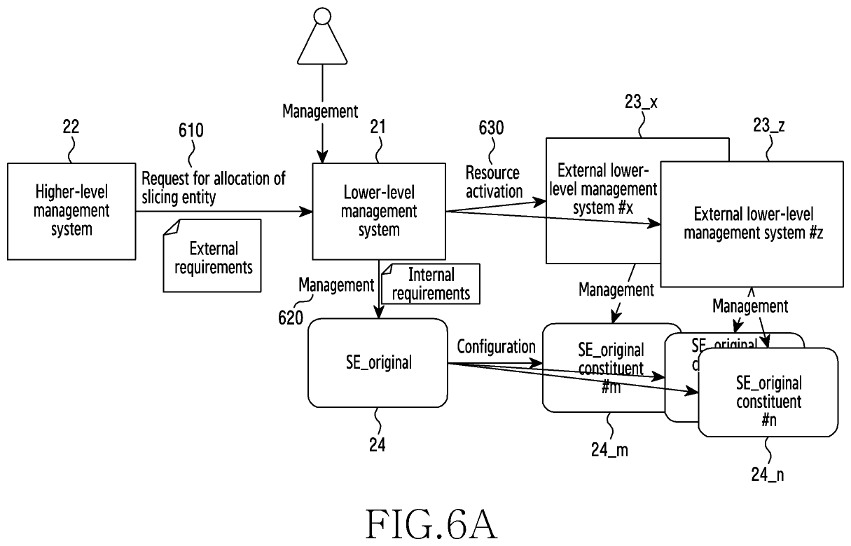

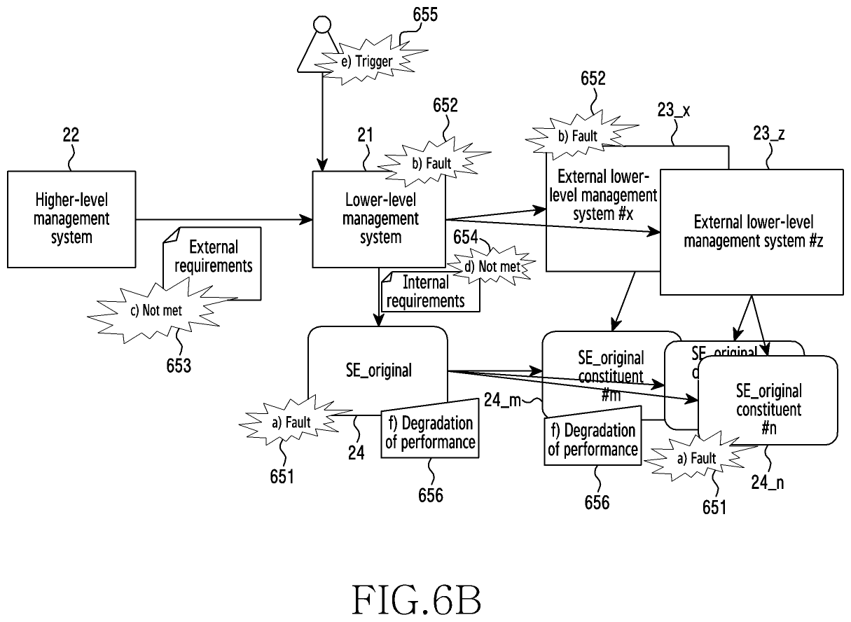

Examples of a reallocation triggering condition of triggering a slicing entity reallocation will be described in more detail in FIGS. 6A and 6B described later.

In operation 550, the lower-level management system 21 may transmit a notification of notifying an intention of reallocating an original slicing entity (SE_original) and the details (e.g., faults, and requirements not fulfilled) of the met reallocation triggering condition, to the higher-level management system 22. In some embodiments, operation 550 may be omitted.

FIGS. 6A and 6B are diagrams for explaining a reallocation triggering condition in a wireless communication system according to various embodiments of the disclosure.

FIG. 6A illustrates operations of management systems 21, 22, and 23 in a steady state, when a reallocation triggering condition is not met (or when a reallocation event does not occur). The higher-level management system 22 may request the lower-level management system 21 to allocate a slicing entity that meets specific requirements (external requirements) (operation 610). In response to the allocation request, the lower-level management system 21 may present corresponding requirements (internal requirements) to an original slicing entity (SE_original) 24 (operation 620), thereby enabling to configure necessary constituents 24_m and 24_n. In response to the allocation request, the lower-level management system 21 may activate resources of external lower-level management system 23_x and 23_z to be available (operation 630), thereby enabling the corresponding constituents 24_m and 24_n to be managed by the resources.

FIG. 6B illustrates potential reallocation triggering conditions of triggering the reallocation of a slicing entity. When one or more of the reallocation triggering conditions are met (or when a reallocation event occurs), a slicing entity reallocation operation may be triggered.

The reallocation triggering condition for triggering the slicing entity reallocation may be one or a combination of the conditions listed in a) to f) below. However, it is not limited to this.
a) Complete or non-total failure of an original slicing entity (SE_original) 24 or one of its constituents 24_m and 24_n (reference numeral 651)
b) Total or non-total failure of a lower-level management system 21 or one of external lower-level management systems 23_x and 23_z (reference numeral 652)
c) Result of not meeting requirements attached to the original slicing entity (SE_original) 24 (reference numeral 653): The requirements may be requirements specified by the higher-level slicing management system 22 in the allocation request, or modified later.
d) Result of not meeting requirements attached to the original slicing entity (SE_original) 24 (reference numeral 654): The requirements may be requirements defined internally by the lower-level management system 21 (e.g., a system administrator or operator).
e) Explicit trigger of reallocation through APIs of the lower-level management system 21 (e.g., a system administrator or operator) (reference numeral 655): The APIs may or may not be exposed for external use.
f) Periodic check that indicates the degradation of performance of the original slicing entity (SE_original) 24 or its constituents 24_m and 24_n (reference numeral 656): when periodic load balancing check that distributes (load balances) a set of requirements among managed slicing entity pools is performed, when the amount of sets of requirements already attached (or connected) to a specified original slicing entity (SE_original) reaches a threshold, when a new set of requirements has a higher priority than a set of requirements already attached (or connected) to the original slicing entity (SE_original) 24 and thus a specific set of requirements needs to be reallocated to an alternative slicing entity, or when other conditions are met as a check result

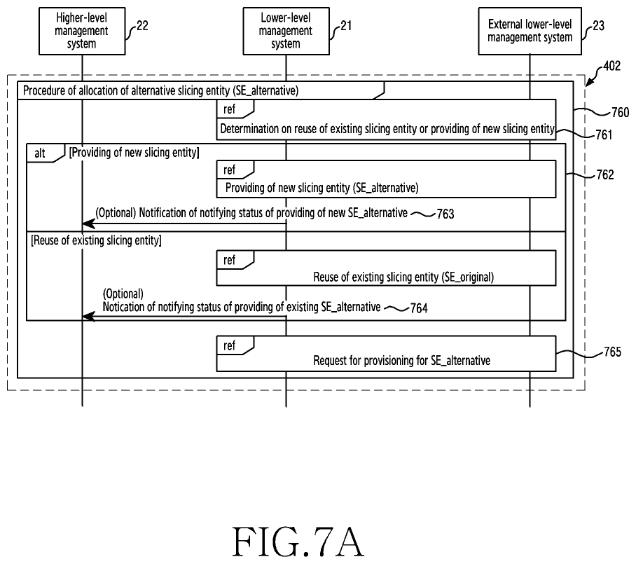

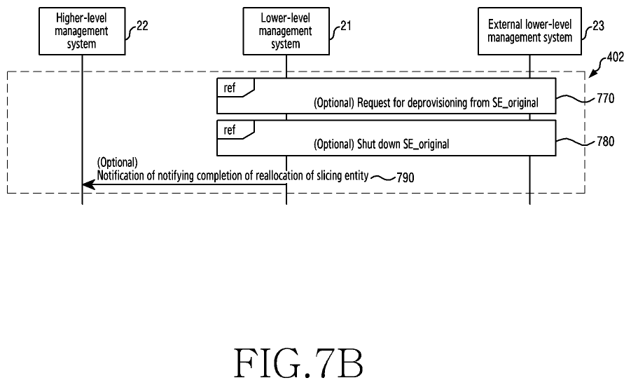

FIGS. 7A and 7B are ladder diagrams illustrating reallocation execution operations when reallocating a slicing entity by a break before make technique in a wireless communication system according to various embodiments of the disclosure.

Referring to FIG. 7A, operation 402 may be a procedure of allocating an alternative slicing entity.

In operation 402, the lower-level management system 21 may reallocate an alternative slicing entity (SE_alternative) that may substitute an original slicing entity (SE_original), in meeting allocated requirements.

A logic for reallocation may be a method of providing a new slicing entity or selecting an existing slicing entity. Compared to selecting the existing slicing entity, providing the new slicing entity may be relatively advantageous to customize specific requirements required for a service. When the existing slicing entity is selected, the time required for reallocation may be shorter, and a rate of resource utilization may be improved, compared to when the new slicing entity is provided. An alternative slicing entity (SE_alternative) may meet original specific requirements attached to the original slicing entity (SE_original). In some embodiments, the alternative slicing entity (SE_alternative) may also meet more than the original specific requirements allocated to the original slicing entity (SE_original) (e.g., in case of intentional overbooking, etc.). In some embodiments, there may be several sets of requirements allocated to the original slicing entity (SE_original). In this case, the reallocation procedure may consider several sets of requirements allocated to the original slicing entity (SE_original), or all sets of requirements to be reallocated to the alternative slicing entity (SE_alternative) from the original slicing entity (SE_original).

Operation 402 may include operation 760. Operation 760 may include operations 761, 762, 763, 764, and 765.

In operation 761, the lower-level management system 21 may determine whether to reuse an existing slicing entity or whether to provide a new slicing entity, based on input requirements, a monitored network environment, and/or an operation policy.

In operation 762, the lower-level management system 21 may selectively execute one of the operation of reusing as an original slicing entity (SE_original) the existing slicing entity that meets the input requirements or the operation of providing as the original slicing entity (SE_original) the new slicing entity that meets the input requirements, according to the determination of operation 761.

In operations 763 and 764, the lower-level management system 21 may notify the higher-level management system 22 of information about a progress of reallocation of an alternative slicing entity (SE_alternative). For example, the information about the progress may include at least some of information notifying that the alternative slicing entity (SE_alternative) is reallocated for input requirements included in an original allocation request from the higher-level management system 22, details information about providing the new slicing entity or reusing the existing slicing entity for use as the alternative slicing entity (SE_alternative), information about one or more of a current status, current function, and current configuration of the alternative slicing entity (SE_alternative), other information related to the alternative slicing entity (SE_alternative), or detailed procedural information executed as part of reallocation related to the alternative slicing entity (SE_alternative). In some embodiments, operations 763 and/or 764 may be omitted.

In operation 765, the lower-level management system 21 may present provisioning requirements for the original slicing entity (SE_original), to the external lower-level management system 23. It may be necessary to perform a management and configuration procedure for allocation of the original slicing entity (SE_original) in both the lower-level management system 21 and the external lower-level management system 23 that is a basis of the lower-level management system 21.

Referring to FIG. 7B, operation 402 of reallocating the alternative slicing entity (SE_alternative) may include operations 770, 780, and 790.

Operation 770 may be performed subsequent to operation 760 of FIG. 7A. In operation 770, by requesting deprovisioning from an original slicing entity (SE_original), the lower-level management system 21 may detach requirements attached to the original slicing entity (SE_original). In some embodiments, operation 770 may also be omitted or substituted with another operation. For example, the lower-level management system 21 may also determine to keep attaching previously attached requirements or its copy to the original slicing entity (SE_original), without deprovisioning.

In operation 780, the lower-level management system 21 may shut down (or terminate) the original slicing entity (SE_original). In some embodiments, operation 780 may be omitted or substituted with another operation. For example, the lower-level management system 21 may also maintain (or preserve) the original slicing entity (SE_original) in an operational state. The original slicing entity (SE_original) may be maintained in an operable state according to a reallocation operation policy wherein the original slicing entity (SE_original) may be used for future reallocation. For example, when reallocation is not triggered due to an error of the original slicing entity (SE_original), the original slicing entity (SE_original) may still be fully operated. When the reallocation is the result of a non-total failure of the original slicing entity (SE_original), the original slicing entity (SE_original) may be non-totally operated. When the reallocation does not meet specified requirements or is the result of an implicit user trigger, the termination of the original slicing entity (SE_original) may not be planned.

In operation 790, the lower-level management system 21 may transmit a notification of notifying the completion of reallocation of the slicing entity, to the higher-level management system 22. For example, the notification may include at least some of identification information of an original allocation request, requirements identification information, identification and details information of the original slicing entity (SE_original), identification and details information of the alternative slicing entity (SE_alternative), procedure status information, or potential change information about requirements. By performing, based on the above notification, a necessary procedure (e.g., an update procedure for operating inventory, database, configuration, etc.), the higher-level management system 22 may maintain integrity between the higher-level management system 22 and the lower-level management system 21. In some embodiments, operation 790 may also be omitted.

FIG. 8 is a ladder diagram illustrating a method of reallocating a slicing entity by a pre-allocation technique in a wireless communication system according to an embodiment of the disclosure.

Referring to FIG. 8, the slicing entity reallocation method of FIG. 8 may be used when a need for reallocation is expected and/or when advance preparation is possible.

Referring to FIG. 8, the operation of reallocating the slicing entity by the pre-allocation technique according to an embodiment may include operations 801 and 802.

Operation 801 exemplifies operations before executing the reallocation of a slicing entity, and may correspond to a precondition for executing the reallocation. Operation 801 may correspond to operation 401 of FIGS. 4 and 5A. Operation 801 may include operation 810 of allocating an original slicing entity (SE_original). In operation 810, the lower-level management system 21 may allocate an original slicing entity (SE_original) by performing operations corresponding to operations 510, 520, and 530 of FIG. 5A.

Operation 802 exemplifies a procedure of reallocating a slicing entity by a pre-allocation technique. Operation 802 may be to reallocate an alternative slicing entity (SE_alternative). Operation 802 may include operations 840 and 850.

In operation 840, the lower-level management system 21 may expect whether a reallocation triggering condition will be met (or whether a slicing entity reallocation event will occur). For example, the lower-level management system 21 may expect that the reallocation triggering condition will be met, when the maintenance or termination of an infrastructure hosting a slicing entity is expected, when an expected key performance indicator (KPI) is degraded due to an expected cause, when a non-total failure of a current slicing entity is obtained, when a previously provided backup slicing entity pool is ready to be used as a target for reallocation, or when a combination thereof occurs.

When the reallocation triggering condition is expected to be met (or when the slicing entity reallocation event is expected to occur), the lower-level management system 21 may proceed to operation 850 and reallocate a slicing entity. In operation 850, the lower-level management system 21 may perform operations corresponding to operation 550 of FIG. 5B, operation 760 of FIG. 7A, and operations 770, 780 and 790 of FIG. 7B, thereby reallocating an alternative slicing entity (SE_alternative).

FIG. 9 is a ladder diagram illustrating a method of reallocating a slicing entity by a late deprovisioning technique in a wireless communication system according to an embodiment of the disclosure.

Referring to FIG. 9, the operation of reallocating the slicing entity by the late deprovisioning technique according to an embodiment may include operations 901 and 902.

Operation 901 exemplifies operations before executing the reallocation of a slicing entity, and may correspond to a precondition for executing the reallocation. Operation 901 may correspond to operation 401 of FIGS. 4 and 5A.

Operation 901 may include operation 910 of allocating an original slicing entity (SE_original). In operation 910, the lower-level management system 21 may perform operations corresponding to operations 510, 520, and 530 of FIG. 5A, thereby allocating the original slicing entity (SE_original).

Operation 902 exemplifies a procedure of reallocating the slicing entity by the late deprovisioning technique. Operation 902 may be to reallocate an alternative slicing entity (SE_alternative). Operation 902 may include operation 940, operation 950, operation 960, operation 970, and operation 980.

In operation 940, the lower-level management system 21 may expect whether a reallocation triggering condition will be met (or whether a slicing entity reallocation event will occur). For example, the lower-level management system 21 may expect that the reallocation triggering condition will be met, when the maintenance or termination of an infrastructure hosting a slicing entity is expected, when an expected key performance indicator (KPI) is degraded due to an expected cause, when a non-total failure of a current slicing entity is obtained, when a previously provided backup slicing entity pool is ready to be used as a target for reallocation, or when a combination thereof occurs.

When the reallocation triggering condition is expected to be met, the lower-level management system 21 may proceed to operation 950 and reallocate a slicing entity.

Operation 950 may include operation 951 and operation 952.

In operation 951, the lower-level management system 21 may perform operations corresponding to operation 550 of FIG. 5B, operation 760 of FIG. 7A, and operations 770, 780 and 790 of FIG. 7B, thereby reallocating an alternative slicing entity (SE_alternative).

In operation 952, the lower-level management system 21 may maintain both the original slicing entity (SE_original) and the alternative slicing entity (SE_alternative) in an operational state for a specified (or given) time. In some embodiments, the lower-level management system 21 may also perform load balancing between the original slicing entity (SE_original) and the alternative slicing entity (SE_alternative).

In operation 960, by requesting deprovisioning from the original slicing entity (SE_original), the lower-level management system 21 may detach requirements attached to the original slicing entity (SE_original). In operation 970, the lower-level management system 21 may shut down (or terminate) the original slicing entity (SE_original). In operation 980, the lower-level management system 21 may transmit a notification of notifying the completion of reallocation of a slicing entity, to the higher-level management system 22. Operations 960, 970, and 980 may correspond to operations 770, 780, and 790 of FIG. 7B, respectively. In some embodiments, one or more of operation 960, operation 970, or operation 980 may also be omitted or substituted with another operation.

When the slicing entity is reallocated by the late deprovisioning technique as in the embodiment of FIG. 9, specific requirements required for a service of a network slice may be allocated to both the original slicing entity (SE_original) and the alternative slicing entity (SE_alternative) for a predetermined period of time. Accordingly, while the slicing entity is changed by the reallocation procedure, down time may be eliminated or reduced.

An operating method of a management node according to an embodiment of the disclosure may be an operating method of a management node in a wireless communication system with a network slicing environment. The method may include, in response to an allocation request from a higher-level management node, allocating a first slicing entity that meets specified requirements for a network slice, to a lower-level management node, obtaining the occurrence of a reallocation event, and in response to the occurrence of the reallocation event, reallocating a second slicing entity that meets the specified requirements among slicing entities managed by the management node, to the lower-level management node.

According to various embodiments, reallocating the second slicing entity may include reusing, as the second slicing entity, an existing slicing entity among the slicing entities managed by the management node.

According to various embodiments, reallocating the second slicing entity may include providing a new slicing entity to be used as the second slicing entity among the slicing entities managed by the management node.

According to various embodiments, obtaining the occurrence of the reallocation event may include determining that the reallocation event has occurred, when a reallocation triggering condition related to the first slicing entity or the lower-level management node is met.

According to various embodiments, the method may further include, when the reallocation triggering condition is met, switching the first slicing entity to an inoperable state prior to the reallocation of the second slicing entity.

According to various embodiments, obtaining the occurrence of the reallocation event may include determining that the reallocation event has occurred, when a reallocation triggering condition related to the first slicing entity or the lower-level management node is expected to be met.

According to various embodiments, the method may further include, when the reallocation triggering condition is expected to be met, maintaining both the first slicing entity and the second slicing entity in an operational state for a specified time.

According to various embodiments, the method may further include one or more of transmitting a notification of notifying an intention of reallocation of the first slicing entity, to the higher-level management node, transmitting a notification of notifying a progress status of reallocation of the second slicing entity, to the higher-level management node, and transmitting a notification of notifying a completion of reallocation of the second slicing entity, to the higher-level management node.

According to various embodiments, the management node may include at least one of a communication service management function (CSMF), a network slice management function (NSMF), a network slice subnet management function (NSSMF), or a network function management function (NFMF).

According to various embodiments, the first slicing entity and the second slicing entity each may include at least one of a communication service instance (CSI), a network slice instance (NSI), a network slice subnet instance (NSSI), or a managed function instance (MFI).

A management node (e.g., the management node 20 of FIG. 2B or the lower-level management system 21 of FIG. 4) according to an embodiment of the disclosure may include a transceiver (e.g., the communication unit 210 of FIG. 2B), and at least one processor (e.g., the control unit 220 of FIG. 2B) connected to the transceiver. The at least one processor may be configured to, in response to an allocation request from a higher-level management node, allocate a lower-level management node a first slicing entity that meets specified requirements for a network slice, obtain the occurrence of a reallocation event, and in response to the occurrence of the reallocation event, reallocate the lower-level management node a second slicing entity that meets the specified requirements among slicing entities managed by the management node.

According to various embodiments, the at least one processor may be configured to reuse, as the second slicing entity, an existing slicing entity among the slicing entities managed by the management node.

According to various embodiments, the at least one processor may be configured to provide a new slicing entity to be used as the second slicing entity among the slicing entities managed by the management node.

According to various embodiments, the at least one processor may be configured to determine that the reallocation event has occurred, when a reallocation triggering condition related to the first slicing entity or the lower-level management node is met.

According to various embodiments, the at least one processor may be configured to switch the first slicing entity to an inoperable state prior to the reallocation of the second slicing entity, when the reallocation triggering condition is met.

According to various embodiments, the at least one processor may be configured to determine that the reallocation event has occurred, when a reallocation triggering condition related to the first slicing entity or the lower-level management node is expected to be met.

According to various embodiments, the at least one processor may be configured to maintain both the first slicing entity and the second slicing entity in an operational state for a specified time, when the specified reallocation triggering condition is expected to be met.

According to various embodiments, the at least one processor may be configured to perform one or more of transmitting a notification of notifying an intention of reallocation of the first slicing entity, to the higher-level management node, transmitting a notification of notifying a progress status of reallocation of the second slicing entity, to the higher-level management node, and transmitting a notification of notifying a completion of reallocation of the second slicing entity, to the higher-level management node.

According to various embodiments, the management node may include at least one of a communication service management function (CSMF), a network slice management function (NSMF), a network slice subnet management function (NSSMF), or a network function management function (NFMF).

According to various embodiments, the first slicing entity and the second slicing entity each may include at least one of a communication service instance (CSI), a network slice instance (NSI), a network slice subnet instance (NSSI), or a managed function instance (MFI).

According to various embodiments of the disclosure, even if a problem situation of requiring reallocation occurs in a network slice, an autonomous reallocation procedure is performed, whereby it is possible to meet a user's expectation of a quality of service (QoS) and a quality of experience (QoE) for a service (e.g., business application) presented through the network slice.

According to various embodiments of the disclosure, a management function is improved, whereby it is possible to present greater stability in maintaining service level agreement (SLA) requirements and service level specification (SLS) requirements.

According to various embodiments of the disclosure, self-healing capabilities through a reallocation procedure are presented to a lower-level management node of a network slice, whereby it is possible to ensure an uninterrupted and sustainable service to a user of the network slice.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An operating method of a management node in a wireless communication system with a network slicing environment, the method comprising:
in response to an allocation request from a higher-level management node, allocating a first slicing entity that meets specified requirements for a network slice, to a lower-level management node;
obtaining the occurrence of a reallocation event; and
in response to the occurrence of the reallocation event, reallocating a second slicing entity that meets the specified requirements among slicing entities managed by the management node, to the lower-level management node.

2. The method of claim 1, wherein the reallocating of the second slicing entity comprises reusing, as the second slicing entity, an existing slicing entity among the slicing entities managed by the management node.

3. The method of claim 1, wherein the reallocating of the second slicing entity comprises providing a new slicing entity to be used as the second slicing entity among the slicing entities managed by the management node.

4. The method of claim 1, wherein the obtaining of the occurrence of the reallocation event comprises determining that the reallocation event has occurred, when a reallocation triggering condition related to the first slicing entity or the lower-level management node is met.

5. The method of claim 4, further comprising, when the reallocation triggering condition is met, switching the first slicing entity to an inoperable state prior to the reallocation of the second slicing entity.

6. The method of claim 1, wherein the obtaining of the occurrence of the reallocation event comprises determining that the reallocation event has occurred, when a reallocation triggering condition related to the first slicing entity or the lower-level management node is expected to be met.

7. The method of claim 6, further comprising, when the reallocation triggering condition is expected to be met, maintaining both the first slicing entity and the second slicing entity in an operational state for a specified time.

8. The method of claim 1, further comprising one or more of:
transmitting a notification of notifying an intention of reallocation of the first slicing entity, to the higher-level management node;
transmitting a notification of notifying a progress status of reallocation of the second slicing entity, to the higher-level management node; and
transmitting a notification of notifying a completion of reallocation of the second slicing entity, to the higher-level management node.

9. The method of claim 1, wherein the management node comprises at least one of a communication service management function (CSMF), a network slice management function (NSMF), a network slice subnet management function (NSSMF), or a network function management function (NFMF).

10. The method of claim 1, wherein the first slicing entity and the second slicing entity each comprise at least one of a communication service instance (CSI), a network slice instance (NSI), a network slice subnet instance (NSSI), or a managed function instance (MFI).

11. A management node in a wireless communication system with a network slicing environment, the management node comprising:
a transceiver;
memory storing one or more computer programs; and
one or more processors communicatively coupled to the transceiver and the memory,
wherein the one or more computer programs include computer-executable instructions that, when executed by the one or more processors, cause the management node to:
in response to an allocation request from a higher-level management node, allocate a first slicing entity that meets specified requirements for a network slice, to a lower-level management node;
obtain the occurrence of a reallocation event; and
in response to the occurrence of the reallocation event, reallocate a second slicing entity that meets the specified requirements among slicing entities managed by the management node, to the lower-level management node.

12. The management node of claim 11, wherein the one or more computer programs further comprise computer-executable instructions that, when executed by the one or more processors, cause the management node to reuse, as the second slicing entity, an existing slicing entity among the slicing entities managed by the management node.

13. The management node of claim 11, wherein the one or more computer programs further comprise computer-executable instructions that, when executed by the one or more processors, cause the management node to provide a new slicing entity to be used as the second slicing entity among the slicing entities managed by the management node.

14. The management node of claim 11, wherein the one or more computer programs further comprise computer-executable instructions that, when executed by the one or more processors, cause the management node to determine that the reallocation event has occurred, when a reallocation triggering condition related to the first slicing entity or the lower-level management node is met.

15. The management node of claim 14, wherein the one or more computer programs further comprise computer-executable instructions that, when executed by the one or more processors, cause the management node to switch the first slicing entity to an inoperable state prior to the reallocation of the second slicing entity, when the reallocation triggering condition is met.

16. The management node of claim 11, wherein the one or more computer programs further comprise computer-executable instructions that, when executed by the one or more processors, cause the management node to determine that the reallocation event has occurred, when a reallocation triggering condition related to the first slicing entity or the lower-level management node is expected to be met.

17. The management node of claim 16, wherein the one or more computer programs further comprise computer-executable instructions that, when executed by the one or more processors, cause the management node to maintain both the first slicing entity and the second slicing entity in an operational state for a specified time, when a specified reallocation triggering condition is expected to be met.

18. The management node of claim 11, wherein the one or more computer programs further comprise computer-executable instructions that, when executed by the one or more processors, cause the management node to perform one or more of:
transmitting a notification of notifying an intention of reallocation of the first slicing entity, to the higher-level management node;
transmitting a notification of notifying a progress status of reallocation of the second slicing entity, to the higher-level management node; and
transmitting a notification of notifying a completion of reallocation of the second slicing entity, to the higher-level management node.

19. The management node of claim 11, wherein the management node comprises at least one of a communication service management function (CSMF), a network slice management function (NSMF), a network slice subnet management function (NSSMF), or a network function management function (NFMF).

20. The management node of claim 11, wherein the first slicing entity and the second slicing entity each comprise at least one of a communication service instance (CSI), a network slice instance (NSI), a network slice subnet instance (NSSI), or a managed function instance (MFI).

21. The management node of claim 11,
wherein the reallocation event corresponds to a reallocation triggering condition related to the first slicing entity or the lower-level management node, and
wherein the reallocation triggering condition comprises at least one of:
failure of the first slicing entity,
failure of the lower-level management node,
failure to meet requirements attached to the first slicing entity,
express trigger of reallocation, and
degradation of performance of the first slicing entity below a predetermined threshold.

22. One or more non-transitory computer-readable storage media storing one or more computer programs including computer-executable instructions that, when executed by one or more processors of a management node, cause the management node to perform operations, the operations comprising:
in response to an allocation request from a higher-level management node, allocating a first slicing entity that meets specified requirements for a network slice, to a lower-level management node;
obtaining the occurrence of a reallocation event; and
in response to the occurrence of the reallocation event, reallocating a second slicing entity that meets the specified requirements among slicing entities managed by the management node, to the lower-level management node.

23. The one or more non-transitory computer-readable storage media of claim 22, the operations further comprising one or more of:
transmitting a notification of notifying an intention of reallocation of the first slicing entity, to the higher-level management node;
transmitting a notification of notifying a progress status of reallocation of the second slicing entity, to the higher-level management node; or
transmitting a notification of notifying a completion of reallocation of the second slicing entity, to the higher-level management node.
